(19) United States
(12) Patent Application Publication
(10) Pub. No.: US 2018/0131735 A1
(43) Pub. Date: May 10, 2018

(54) Systems and Methods for Content Capture, Distribution, and Management

(71) Applicant: Gregory Melchin McGregor, Walnut Creek, CA (US)

(72) Inventor: Gregory Melchin McGregor, Walnut Creek, CA (US)

(21) Appl. No.: 15/269,973

(22) Filed: Sep. 19, 2016

(51) Int. Cl. H04L 29/06; H04W 4/021; H04W 4/06; H04N 21/2187; H04N 21/8355; H04W 4/21; G06Q 50/00

(52) U.S. Cl. CPC H04L 65/4076; H04W 4/021; H04W 4/06; G06Q 50/01; H04N 21/8355; H04W 4/21; H04N 21/2187

(57) ABSTRACT

The invention includes a system and method for broadcasting concerts, sporting events, and other entertainment content directly from a cellular phone, smart TV, or similar device owned by the content creator to the cellular phones or similar devices owned by viewers worldwide. The system and method also includes the ability of users to bid for, or otherwise request, the right to rebroadcast the content. These users may have to go through a qualification process, which is part of the invention, before being given permission to broadcast the content. The invention includes the ability to utilize geo-fencing to only allow certain users in an area to be allowed to rebroadcast the content. Users in a specific area, or who have certain other characteristics, can also be blocked from viewing the content. Content creators can therefore get their content directly to potential viewers, and control who gets to rebroadcast their content.

### BACKGROUND

The present invention relates to systems and methods for the capturing, recording and distribution of live media content and in particular controlling or managing the streaming of this content according to a number of rules which are alterable by, amongst others, the creator of the content, or the performer. The present invention helps to eliminate the “middlemen” such as cable providers, and ensures that content such as music recordings and sports events can be sent directly from content creators to viewers, thus lowering prices in some cases, or enabling profits to be split between the content creator and fewer other entities in other cases.

In a normal environment, the performance of arts, such as musical or theater arts, and sports in particular, has been carefully controlled so that performances are broadcast or recorded and distributed using pre-arranged contracts or agreements. Media equipment has been traditionally bulky and has required the skillful arts of an expert camera-man or recording technician to capture a highly faithful audio-visual record of an event or performance. Distribution has also been carefully controlled, by nominating a preferred distribution mechanism and paying special attention to the management of this channel to deliver content to the consumer or subscriber.

Typically, a live broadcast is a technically sophisticated operation, and other than editorial delays of a few seconds, introduced for the purposes of controlling or limiting errors, such as inappropriate use of language or profanity on the part of a broadcaster, announcer, interviewee or surrounding audience group, the broadcast program or content occurs as it happens. In general, the availability of content is subject to local regulations and commercial decisions; for example, a live broadcast of a local sporting event is not preferred by the broadcaster or the performer (where in this case the term ‘performer’ also means ‘participant’ in the context of a sports team) because this competes with ticket sales for the event itself. The simultaneous live broadcast outside the local area is of less concern since it does not generally compete with live attendance, and so is beneficial to the distribution channel members because it promotes currency and encourages a fan base.

Recordings of live broadcasts made by the broadcast recipients are generally of poor quality and do not represent a serious threat to the sale of high quality recordings as an aftermarket strategy on the part of the content owners. Whereas it is certainly true that there exists a market for distressingly poor recordings of broadcast material or cinematic display materials, these consumers are not generally likely to represent a lost opportunity for the original content provider since they are often from a less affluent demographic or from a consumer demographic that does not usually engage the higher quality market.

By contrast, recordings intended to be used as masters that are suitable for re-broadcast or making commercial recordings for distribution in any of the consumer media forms are of exceptional quality, and copies made at the “receive” side of a broadcast channel are compromised by the broadcasting transmission and reception processes. The technologies to restore quality or mask noise and artifacts exist, but it is very difficult to achieve good results at an economic point that makes the effort worthwhile.

Recently, the availability of low cost, high performance consumer devices, coupled with highly effective streaming technologies based on the internet infrastructure, has meant that what was previously the exclusive preserve of the professionals with deep pockets and extensive distribution channels has now become more easily accessible to the casual consumer without significant outlay. It is practical for a consumer to use an device such as a tablet computer equipped with a good resolution camera module and capable of good acoustic resolution to capture a performance and transmit it in close to real time. The transmission can be received in close to original fidelity and edited to professional standards, using freely available computing tools, prior to re-distribution.

A clear concern arises from an unfettered ability to capture or harvest events from the perspective of a performer or organizer. Physical premises attempt to limit the extent of unauthorized recording by banning the practice and then simply policing the environment to locate miscreants. Despite this, unauthorized recordings continue to surface from even the most secure of locations and the mere presence of “bootleg” material devalues a performer's art. No more evident is this problem than in the real time or “as it happens” live broadcast or distribution. Streaming services are quite pervasive, with numerous applications that function in a personal device computing environment making them almost ubiquitous.

It is therefore apparent that an urgent need exists for a method to control or limit the extent of this practice so that a performer or presenter may at least influence the distribution of what might reasonably be considered to be protected material. These improved Systems and Methods for Content Capture, Distribution and Management enable the performer or presenter to determine the way that material or content is captured and, in addition, to levy a fee for the performance on a fair and reasonable basis, giving due consideration to the reach and availability of the selected channel.

A blackout is the term used to describe a limitation on distribution. In the conventional broadcast industry, blackouts are often used to limit competition by controlling availability of information using either a regional or geographic constraint parameter or a temporal parameter. For example, where a significant stadium event may be planned, live broadcast may be made available to locations that are outside the capture area for the event. This means that a viewer within a defined area would need to attend the event to witness it in real, or close-to-real time. Another example would be where the broadcast is delayed in time so that a local audience is unable to view the action as it happens. Yet another example is where copyright concerns or rights restrictions do not allow material to be broadcast to a certain area. It should be clear that the term “geographic” in the context of this explanation may apply not only to the physical geography, but also to the virtual geography such as the IP address spaces when material is being distributed using an internet connection. It should also be clear that the existence of Virtual Private Networks and Proxies mean that remote access, which is essentially anonymous, is a known method of accessing information that would otherwise be restricted. The present invention gives a performer the option to “black out” an area around a concert or other event, whether that area is defined geographically or by other means, to ensure that only the performer, or parties authorized by the performer, can record and broadcast the event.

Here, we will look at some specific prior art inventions. Application 20160006981 by Baum discusses a scheduling and hosting website that allows a user to choose a host with whom the user is interested in communicating, and to make a request to participate in a communication event with the host. The website also automatically processes one or more requests from one or more users, executes a method specified by the host or others in response to the requests, selects a user based on pre-determined rules, schedules the communication event, and hosts the communication event at the scheduled time and date. Baum's specification clarifies that Baum's invention is focused on arranging one-on-one sessions between influential individuals and people who want to talk to them. This is different from the present invention, because Baum's invention does not include the ability for users to rebroadcast an event, or other content, with permission of the content creator. Furthermore, the present invention includes the ability to use “geo-fencing” to limit rebroadcast of content to users who fulfill certain characteristics. There is nothing similar in Baum's invention, and indeed, the purposes of Baum's invention would not require such abilities.

Patent Application 20150249845 by Tiroshi et. al. discusses a method for uploading live video as it is created by breaking it into segments and sending it to a server, where others can view it. There is nothing in Tiroshi's application about allowing users to rebroadcast events, or use of geo-fencing to limit rebroadcast of content to users who fulfill certain characteristics.

Patent Application 20150378584 by Folgner et. al. discusses a method of sharing media broadcasts by breaking the broadcasts into clips, stored on a server, selecting clips based on characteristics selected by the person utilizing the invention, and then sharing these clips with others. This is different from our present invention, because our present invention uses live broadcast of events.

### SUMMARY OF THE INVENTION

### Term Numbers and Terminology

The following terms refer to various features of the invention, or steps in different processes connected to the invention. (20) Bidding application. Server (25). (100) bidding region. (10) Controlling application. (12) Content creator application. (15) Condition process. (102) Controlling agency. Content (30). Receiving server (35). viewer application (40). receiving device (45). Authorization determination step (50). content delivery step (60). user denied access step (70). Geo-fencing guidelines (80). Geo-fencing guidelines input interface (86). Condition process (15).

Types of individuals and entities using the invention shall be defined as follows: Content creators are entities (Including, but not limited to, individuals, music groups, and sports teams) who create audio and/or video content and want to broadcast it to others using the invention. Please note that, in this patent application, employees or agents of the content creator can sometimes interact with the invention on behalf of the content creator and perform tasks such as deciding which users get to re-broadcast an event. Therefore, when a content creator is described as doing something, it is understood that the term content creator includes the employees and agents of the individual, music group, sports team; etc. who has created the content. Users are entities (Including, but not limited to, individuals, music groups, and sports teams) who wish to broadcast content created by content creators using the invention. Viewers are entities (Including, but not limited to, individuals, music groups, and sports teams) who want to view content using the invention. An entity can, with reference to different pieces of created content, be a content creator regarding some pieces of content and a user regarding others, a content creator regarding some pieces of content and a viewer and a user regarding others, a user regarding some pieces of content and a viewer and a user regarding others, or all three regarding different pieces of content. A bidder is a user who is bidding, or has bid, to have the right to re-broadcast an event. Therefore, all bidders are also users. Viewers, users, and content creators are all categories of subscribers.

Most cellular phones, tablet computers, Ipads, and other devices with similar capabilities are continually electronically monitoring their own locations through satellite triangulation, cellular tower triangulation, GPS (the Global Positioning System), connection to local Wifi networks, and other methods. Android and Apple mobile phones/devices/tablets are able to provide their location down to the foot, given enough information. For example, if the mobile phone is in a building and has no view of the sky for GPS satellites, the local WiFi or hotspot recognition would place the phone in the building. If there is not hot spot, cellular triangulation would place the phone near or in the building. Many features of these devices, and many apps and programs on these devices, need to know the devices' locations in order to function. A smart TV also needs to know its location, because it needs to connect to the owner's home wireless network, and therefore the smart TV can identify its location by the fact that it is connected to the network.

Geo-fencing involves an app or program on one of these devices, such as a smart TV, cellular phone, Ipad, tablet, or other type of computer, determining when the device enters a specific area. The area may be geographical or may be defined in another fashion, such as via IP addresses. The app or program can do this, because the device is already monitoring its own location. The app or program can interact with those parts of the device's internal hardware and software that monitors the device's location, and get information about the device's location from this hardware and software. Once the device has entered a geographically defined, or otherwise defined area, the app or program involved in the Geo-fencing may have the ability to make alerts via text or video, or to display messages to the user, or to activate or de-activate features of the app or program. For example, the app can be designed to prevent viewers from viewing certain content on a device, once the device moves within the boundaries of a specific geographic area.

“Push notifications” are notifications where, when a specified event happens, a user immediately gets a message that is loosely analogous to a text message on his or her cellular phone or similar device. An example might be a push notification saying “X has written a comment on your Facebook wall” where X is a person.

Currently no app or program gives subscribers the ability to set up their own geo-fence quickly via connection from their device to a remote server, or to specify characteristics of that geo-fence quickly via a screen or other interface that gives a subscriber the ability to designate characteristics of the geo-fence quickly and in a standardized manner. No app or program also allows a subscriber to designate specific other subscribers to be allowed to broadcast or re-broadcast content, thus exempting those subscribers from the geo-fence. No app or program includes a feature that allows other subscribers to compete for the right to be exempted from the geo-fence and to re-broadcast an event, and gets the information about the relevant characteristics of the bids to the content creator in a quick, standardized, and easy-to-compare manner.

Embodiments of the present invention will involve an “app”, an application or program that can be downloaded to a smartphone or tablet computer, or other type of computer or device with similar capabilities to a smartphone or tablet. The term “device” may refer to any smartphone, or tablet computer, smart TV or other type of computer or device with similar capabilities to a smartphone or tablet, or smart TV, for purposes of this application. The app, once installed on the device, and activated, determines the location of the device, and uses methods known in the art to communicate with a server (25). Some embodiments of the app, which can be downloaded to a person's smartphone or tablet computer, allow a person who has downloaded the app to act as a content creator, a user, or a viewer with regard to different events. A content creator can also use the app's geo-fencing capabilities to control which viewers get to view the content, and which users get to broadcast the content. The app downloaded to a subscriber's device is called the controlling application (10). A version of the app that only allows a subscriber to view content is the viewer application (40), and a version of the app that only allows a subscriber to broadcast content is a content creator application (12). A “user application” that only allows a subscriber to rebroadcast content is also part of the present invention.

The software of the present invention also involves an overarching “controlling agency” (102) that includes, but is not limited to, the software components that ensure that data streams containing the audio and visual content produced by the content creator are sent to the user(s) and viewer(s) who are authorized to receive it, and also sets the “override values” for the geo-fencing network that is set up by the content creator.

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting; having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for capturing the content of a live performance, such as, for example, an impromptu musical performance (“gig”) or a theatrical rehearsal, and then transmitting this information in close to real time to a group of viewers or listeners. The data transmission needs may generally be supported using a wireless connection between some or all of the parts of the system. In particular, the system is configured so that users or distributors may bid on the opportunity to be the sole distributor, or one of the distributors, of that live performance. Access to the system may be through a controlling application (10) that runs on the consumer device being used to capture the performance information, and the controlling application (10) may request information from the content' creator prior to its use for data capture. The controlling application (10) or user application In particular, the content creator may interact with the application and bids from users are solicited under the supervision of an overarching controlling agency that considers a number of user parameters.

Amongst these may be the scope of the user's distribution capability, or access to audience such as social media “followers.” Another user parameter may be financial in nature and be used to determine the perceived value of the arrangement; for example a user may choose to expose 100,000 followers to the performance without charge, but contribute a sum for the rights to be the sole distribution using the invention. In another example, the user may elect to offer a free trial period to his or her subscribers or followers prior to collecting a subscription amount for the balance of the performance. The user may then bid to offer a percentage of the amount received to the content owner, the performer or other controlling entity. The percentage of the amount received can vary, and the user can offer different percentages, depending on his or her desires. The controlling agency can also be designed to consider other user parameters. The controlling agency may directly decide which user(s) have the right to rebroadcast the event, or may make the information about the user parameters of each bidder available to the content creator, for the content creator to decide this.

In part, the system or application may accept only a single subscriber to be allowed to stream the content of the performance. Other subscribers will not be permitted to stream live content using this application from that event at that location. In part, the system or application will be location aware so that regional restrictions may be imposed on viewers or listeners. The content creator can select these, because when he or she starts the process for recording the event, the content creator will be presented with the Geo-fencing guidelines input interface (86) where the content creator will be able to create a geo-fence disallowing others besides that single subscriber (who may be the content creator or a user) from using the invention to stream the content of the performance. The content creator will therefore ensure that only one streaming of the performance is being made via the invention, which will ensure the monetary value of access to that one streaming of the performance, allowing the streaming to be a source of revenue.

For example, if an event, such as a “jam” session for performers or collection of performers is to be held at a venue that is sufficiently sized so as to allow a large number of attendees to be present, then the system or application may “black out” or make the live stream unavailable to regions surrounding the event. This exclusion region may be specified by any of the performers, the distributor or the controlling agency, for example. The exclusion may be created for groups of viewers or listeners or may apply to individuals; such exclusions may be created to satisfy regulatory requirements that limit content based on age, or religious obligations with time constraints such as fasts or mandatory prayer times, or any other basis.

The content creator or its agents can specify this, ahead of time, by inputting geo-fencing guidelines (80) into the geo-fencing guidelines input interface (86) before the beginning of the performance. As long as these geo-fencing guidelines (80) do not contradict the overriding values imposed by the controlling agency (102), the geo-fencing guidelines will be sent by the content creator's device to the server (25) where the controlling agency (102) will impose the geo-fencing guidelines, copy them on the server (25) and any receiving server (35) and prevent others who do not meet the criteria specified in the geo-fencing guidelines from accessing the live stream of the performance. The controlling agency (102) checks the characteristics of each subscriber who attempts to watch a performance live via the invention, based on the information that the subscriber had to input when they signed up for the invention. The controlling agency then only allows those subscribers who meet the criteria specified in the geo-fencing guidelines to access the livestream of the performance.

Other embodiments of the app, which can be downloaded to a persons' device, include the capability to engage in one or two of the roles of the content creator, user, or viewer.

Once any version of the app, including the controlling application (10), viewer application (40) content creator application (12) or user application, is downloaded to a device, the person using the device must create an account, with the app, in order to use the app. The account identification information entered by the user will be stored on the server (25) in most embodiments. In most embodiments, the person owning the device will have to pick a username and password, and enter account information such as his or her real name, age, and phone number, and a method of payment for purchased content. The person owning the device may also have to enter other information, such as a physical address, in some embodiments of the invention. This information may all be stored in a “user identification database.”

The account information entered by the subscriber will be used later by the version on the app running on the device, and by the controlling agency, to identify the device. This information can also be used by a content creator to determine when and whether the device and its owner will be allowed to broadcast or view specific content.

The app permits each content creator to simultaneously broadcast content to every viewer worldwide, who fits the geo-fencing criteria that have been placed on the broadcast by the content creator. The content creator can also give specific users permission to broadcast the event.

This gives the following advantage to the content creator. If a content creator wishes to broadcast an event to an audience, or perform the event in front of an audience, and one or more users in that audience have permission to broadcast the event, then those users will be able to broadcast the event to their social media connections who also have a viewer application (40), or controlling application (12). The exclusive or near-exclusive right to broadcast or re-broadcaster an event adds potential monetary value for a user. The content creator can also set up a geo-fence to block everyone within a certain distance, or having certain characteristics, from recording and/or broadcasting the event. The content creator can therefore offer exclusivity regarding directly broadcasting the event, or sending the data feed, which is started, to one user, increasing the value of the live stream of the event to the content creator and the user. The content creator can also set up the geo-fence to “black out” all recording via the invention within an area of 500 feet, 1000 feet, etc., so that the content alone has the right to record and live-stream the event, livestream it via the invention, and send the livestream to users who can then re-broadcast the livestream to their followers. This, in turn, would increase the monetary values of the live stream to the content creator. If a user has large numbers of connections on social media, including, but not limited to, Facebook friends and Twitter followers, then that user will be able to broadcast the event to those individuals, which increases the number of people whom the content creator is able to reach with his or her content. The content creator can therefore leverage the social media power of the users. The users, for their part, can earn money, in the ways described elsewhere in this application.

In the preferred embodiment of the invention, when a content creator decides that he or she wants to broadcast an event, the content creator would activate the controlling application (10). The content creator would input his or her username, password, and other authentication information. This would be sent to the server (25), which would then authenticate the content creator. The account information of the content creator would be identified, and would be available for use in any necessary processes. After logging in, the content creator would then click on a software button within the app, perhaps saying “Go Live”, and would be presented with an “condition process” (15) that would display metadata relevant to the event. The content creator could alter that metadata. In that metadata, the content creator could state the requirements for a user to be allowed to re-broadcast the event. This might filter out requests from users who do not meet the requirements. Some of the requirements might be, A. That re-broadcasters split the revenue with the content creator 50/50, B. That re-broadcasters have social media followings of over 1,000,000 followers, C. that re-broadcasters for an event be split evenly between males and females, or D. required age demographics for the re-broadcasters.

“Override values” can also be placed by the controlling agency to enforce particular rules. These override values would most likely be stored on the server, and the server would review these override values to see if any of them apply to the event that the content creator wants to broadcast. These override values can be stored in a separate override values database (120) on the server or elsewhere. These override values will be values that the content creator cannot change, and where the content creator cannot create requirements for re-broadcasters that are outside the limits specified by the override values. For example, the override values could require that all re-broadcasters be over the age of 18 at the time of the re-broadcast. The content creator could also alter the meta data to even auto accept all potential re-broadcasters that are not outside the override values.

An optional title would also be available, and the content creator could alter the title if desired. Other information about the event, such as an optional summary of the purpose of the event, may also be available, and the content creator could alter this if desired.

After this information is entered, the device locator feature will use the hardware and pre-installed software of the device to find the physical location of the device. Please note that this step could theoretically be performed as soon as the content creator activates the app. However, in the preferred embodiment, this step is performed after the user enters this information into the condition process.

The app on the content creator's device will then display a geo-fencing guidelines input interface (86) that will give the content creator the option to put up a geo-fence if the area is not already blocked by an existing geo-fence. The content creator can select the size of the geo-fence (500 feet wide, 1000 feet wide, etc.), and can select other characteristics of the geo-fence, such as viewers of a certain age may be blocked from seeing the event. Viewers who have not paid, viewers with certain IP addresses, those who have indicated that they only wish to see certain types of performances, those from specific geographic areas, or those who have specific religious obligations could also be blocked from seeing the event. Other types of criteria can be created, by which viewers may be blocked from viewing the event. The app then sends this information to the server (25). The controlling agency (102) which is running on the server then receives the information, and sets up the geo-fence.

The controlling application may be in any form that will operate appropriately in conjunction with the content creator device; for example, this may be a HTML5 implementation that operates as a browser session or it may be a Java Script program or any similar program. Xamarin products with C#, Apple IOS and Objective-C along with Android along with others. This is important to note because streams can be viewed on devices like Roku, AppleTV, Amazon TV and more. Devices like mobile phones that have a camera, allow the users to broadcast live video under the rules and terms of this invention. As an example, a developer could take the Microsoft Xamarin product and write a mobile application for Android, IOS and Windows Phone in the C# language.

### BRIEF DESCRIPTION OF THE DRAWINGS

In order that the present invention may be more clearly ascertained, some embodiments will now be described, by way of example, with reference to the accompanying drawings, in which:

FIG. 1 is a Process Flow Chart, in accordance with an embodiment of the invention and shows how the elements of the invention are generally related in one embodiment; and

FIG. 2 is an explanation of the basic process that a content creator will undertake, to make a performance or other event available for viewing and re-broadcast in one embodiment.

FIG. 3 is a screenshot of what a viewer might see, when he or she tries to do an in-app purchase of the right to view an event, using the controlling application (12) or the viewer application (40) in one embodiment.

### DETAILED DESCRIPTION OF THE DRAWINGS

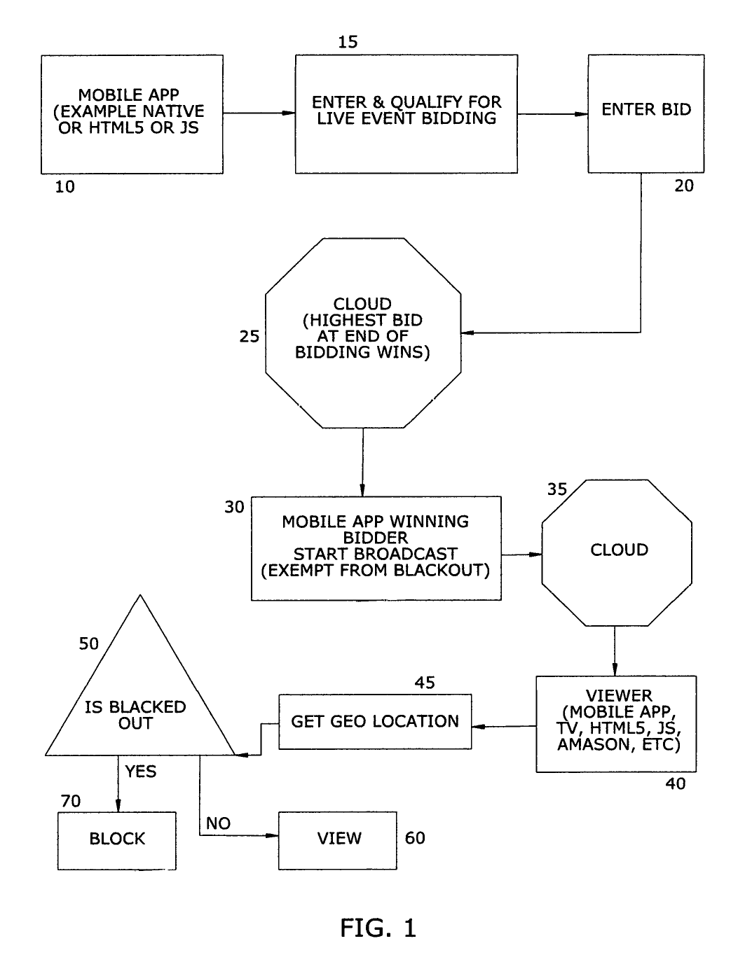

To facilitate discussion, FIG. 1 shows a flow chart that illustrates one embodiment of this invention. On a personal device which is capable of interacting with the intended activity to capture and record content of a pre-planned or impromptu performance or event, a controlling application (10), is enabled that enables a user of the device to exchange information. This information may be linked to a controlling agency, such as a program running on a server, which, in response to receiving information from one or more content creator devices, sets parameters that determine how any of the content creator devices and other devices should operate in regards to the application. For example, a parameter that controls some or all of the recording that will be attempted by the user may be used to limit the fidelity of capture or even prohibit capture of a particular session or performance. This parameter setting may be based upon the geographic location of the device which may be determined in any of a number of ways discussed elsewhere in this patent application.

Once a content creator invokes the application, the content creator is shown a condition process, 15, that allows the content creator to specify that the content creator wants to initiate a broadcast, and the conditions that the content creator wishes to operate under. For example a content creator may enter the performance details, either as a discrete entry, or may select the performance from a number of choices. The content creator may also enter an event title. The controlling agency, may be able to retrieve, and send to the controlling application, a number of pre-determined performance types from a server (25) but the content creator may also be able to specify or initiate a new type of event which is currently unknown to the server. The content creator may enter information that identifies the content creator and permits the server to verify the claimed capability and authenticity of the content creator.

In the case where an event is spontaneous and a content creator wishes to distribute information that is to be captured, the content creator may add this information to a brief summary of the event which is sent to the server, via the controlling application, for the attention of a moderator. The moderator may be a person or an algorithm.

The content creator then is shown the Geo-fencing guidelines input interface (86) where the content creator selects the Geo-fencing guidelines (80). If these do not violate any override guidelines and the area being geo-fenced has not been claimed already, the requested geo-fence is set up by the controlling application. If the selected geo-fencing guidelines do violate the override guidelines, or the area, or part of it has been claimed, the content creator will receive a message saying this, and the content creator will have to select different boundaries for the geo-fenced area.

The geo-fencing guidelines are implemented as follows: A module (The plotting module) within the controlling agency takes the location of the content creator's device (which is already known to the controlling agency because the device sent this information to the controlling agency when the controlling application contacted the controlling agency). Then, the module plots an area around that location, with a radius which is equal to the content creator's requested geo-fence radius. The module determines whether any geo-fence previously requested by a user, will take up any of the same area. If not, the controlling agency reserves the requested area for the content creator's geo-fence, and the plotting module informs the rest of the controlling agency to reserve that area for that specific content creator.

In an embodiment of the invention, the geo-fence reserved by the content creator starts when the content creator's event starts, and disappears when the content creator's event ends. The content creator must input these times into the controlling application, which sends them to the server.

The invention can also create geo-fences that are not circular, at the request of a content creator.

The content creator may select a blackout area of 100 miles wide, or smaller, as examples of the necessary area to ensure that people who desire to see the event, who live in that area, physically go to the event.

The content creator may then, if the content creator so chooses, send a “push notification”, email message, or text message to a group of people, including, if the content creator chooses, all of the content creator's social media followers, announcing the event.

The content creator is then returned to the condition process. The content creator may also, through the condition process, select whether the users who get to rebroadcast the event should be selected via an algorithm or by the content creator, and also decide whether the event should be paid or unpaid.

If a user wishes to re-broadcast an event, then the user logs into the application, thus permitting the controlling process and server (25) to identify the user and verify his or her capabilities, and the user then enters the condition process, which also has an option for re-broadcasting events. The condition process allows the user to specify the conditions that the user wishes to re-broadcast under. The user may wish to broadcast one of the events already listed on the server. A list of such events will be presented to the user by the condition process. The user may also choose to rebroadcast an event that is presently unknown to the server.

The controlling agency operating on the server may then ask the user additional questions, which may come in a pre-set list or have been previously decided by the content creator. The controlling agency and server use the information that the user has provided to verify the user's capabilities. For example, a user may claim to have a large number of followers on a social media site which implies the ability to distribute the performance to a substantial group of consumers. The server may respond to the bidder by testing any proposal aspects, such as a claim of distribution capability, for veracity. In another example, the user may be listed as a preferred or pre-qualified distributor of content by the content creator or its agents. The server may present user information to a person or use an algorithm to determine if a user is acceptable as a distributor for the performance or event which is to be captured. The performer or event sponsor may pre-define the acceptance criteria.

The controlling agency uses “scraping”, a technique by which the application ascertains the number of social media followers that a user has, by capturing information from the user's Facebook, Myspace, Twitter, YouTube, and other social media profiles. In cases where this “scraping” cannot be done, it will be possible for a human moderator to manually examine the user's social media profiles and determine the number of the user's social media followers from these. Techniques for “scraping” are known in the prior art.

The information about the number of the bidder's social media followers will be processed in a manner depending on the information and preferences initially entered into the condition process (15) by the content creator. If the content creator has decided that bidders with less than a certain number of social media followers should be rejected automatically, the information about the number of the user's social media followers may cause the bidder to be rejected automatically if this number is below a threshold set by the content creator. If the content creator wants to personally decide whether to accept or reject the bidders instead of allowing a computer algorithm to decide this, the number of the user's social media followers is then made available to the content creator, so the content creator can decide whether to allow the user to re-broadcast the event.

If the content creator decides to have an algorithm select the bidders who will be allowed to re-broadcast the event, the number of the bidder's social media followers is placed with the other information that the bidder has submitted, through an automated bidding process. If the bidder does not meet the content creator's minimum threshold, for the number of social media followers that a re-broadcaster of the event must have, then the bidder will be notified that he or she does not have permission to re-broadcast the event. If there is no minimum number of social media followers set by the content creator, or if the content creator has set a minimum and the bidder meets the minimum, the algorithm might award the bidder the right to re-broadcast the event depending on the other criteria discussed herein.

The content creator can design his or her own algorithm for making this decision, or can use an algorithm embedded in the controlling agency. Some of these algorithms embedded in the controlling agency include requiring a user to have a minimum of 1,000,000 social followers, and paying a minimum fee per viewer, as their inputs. Another algorithm allows the bidders to simply bid a dollar amount for the right to re-broadcast the content, and the highest dollar amount wins. In some embodiments, a list of the available algorithms will be sent from the controlling agency to the controlling application (11) and will be displayed on the controlling application for potential selection by the content creator.

The system can also be configured so that the content creator receives a push notification whenever a user wants permission to re-broadcast a piece of the user's content.

Subsequent to receiving a qualification approval from the server, which may simply show that the user is qualified to bid on the right to re-broadcast the event, the user (who is also a bidder) may then be taken to a bidding region (100) within the controlling agency that allows the user to bid (bidding application), 20, for the opportunity to distribute the material captured from the performance or the event. The bidding may be financial in nature and may incorporate other components. For example, the user may offer to pay a fixed amount for the opportunity to the content creator or else may offer to pay a percentage of monies (the percentage is picked by the user) received from consumers of the content that is captured and distributed by the user. In general the proposal from the user may be similar to any formal agreement that may be entered into before the pre-agreed recording and distribution of material from a formal performance or event.

Bidding information from one or more users is transmitted to the server, 25, and a determination is made at a predetermined Time, by either the content creator or the controlling agency (via algorithm) to award the opportunity to at least one of the users. At his time, the unsuccessful bidders may be informed that their bids have not been successful and the control application on their device may receive information that prevents the application from interacting with their media recording components, when within the geo-fenced area, colloquially their controlling applications are set to a blackout condition. In another embodiment, the users' devices might all have been set to be in a blackout condition within the geo-fenced area, unless the devices received information allowing the controlling applications on these devices to operate within the geo-fenced area. The only device that receives that information, in this case, will belong to the winning bidder. In one implementation, the recording by a losing bidder is permitted and maintained local to the user's device so that it may only be played by the controlling application on that device. In another implementation, the recording on the user's device is expunged after either a pre-determined number of viewings or after a time period has elapsed.

The selected user who has won the bidding element of the contest to secure broadcast or distribution rights may receive a notification of success and the controlling application on the user's device may then be set to capture and send the content, (30), to a receiving server, (35). The winning bidder will either receive a message about how to do this, or the program will do it automatically. A winning bidder may be ascribed a code that may be inserted into the information stream transmitted to the receiving server (35) so that the received stream may be verified at various times to ensure that the information may be identified as being from the correct user. The blackout exemption lasts until the event has concluded or has been terminated, at which point the user's device is reset to the idle, no-broadcast mode.

The receiving server, (35), receives information from a content creator (In cases where the content creator opted to directly record the event) or winning bidder. The data-stream that comprises the content that was captured by the winning bidder may be parsed to extract identifying information that may be embedded in the data and this identifier may be compared to a list to ensure that the information is properly authorized for distribution. Information which is verified may be stored at the server and may be distributed immediately as a live data stream to subscribers to the event. A subscription by consumers, listeners or viewers may be performed in a number of ways known in the art and may be fee bearing or not; in one implementation, an initial period may be free followed by a period for which a charge may be levied. The financial component of a consumer's transaction may be determined by a prior agreement or may occur interactively during the consumption of the performance as is common practice, often referred to as an “In App Purchase” agreement.

The application for capturing content may also support viewing. However, in one implementation, the “viewer application”, (40), is a separate application that only allows the consumption of content and not its capture. A viewer may invoke the viewer application, (40), or controlling application, and may be offered a choice of performance data streams according to viewer preference. For example, a viewer may enter the viewer application, (40), or controlling application, and store a list of favorite performance categories defined by any of location, artist, activity and so forth. A user may also be permitted to browse though a list of current or archived data streams of recordings of events, and select one or more to be viewed or listened to. In one implementation, a user may select a live stream and be provided with the content starting from the beginning of the stored stream. The controlling agency will send this information to the controlling application on the user's device. The live stream may come from the receiving server (35) which will send it to the viewer.

During the selection process, the viewer or user wishing to see or listen to the content may be prompted for the viewer's location to determine if any blackout restrictions are in force. The location of the receiving device, (45), may be confirmed in any of a number of ways; GPS positioning information may be acquired, the location of the device determined by the IP address which is in use for the communication or else the location of a wireless service point may be used. Further, consumer status may be tested to determine if the device in use is a duplicate of another device or if there is fraudulent use of the viewer account; these tests are known in the art.

The authorization for a viewer's device is then determined (authorization determination step), (50), and either the content is delivered for viewing, (content delivery step) (60), or viewer the user is denied access, (viewer denied access step) (70). If access to the content is denied, the server may provide information that is helpful to the subscriber (A viewer in this case), such as possibilities for viewing the content at a later time or for accessing alternative content. In one implementation, a viewer subscriber may be offered an opportunity to access a low fidelity version of the content.

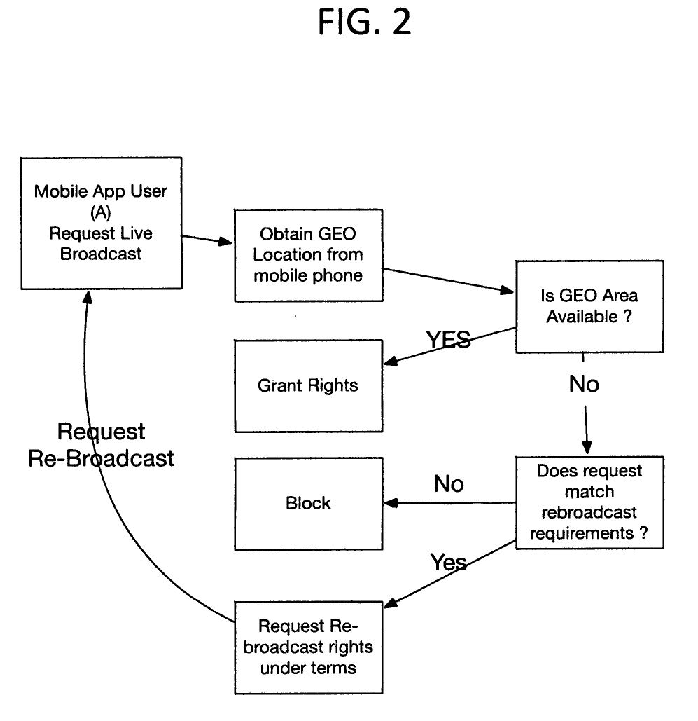

FIG. 2 shows a flow chart of, first, the content creator creating the geo-fence and requesting re-broadcast, using his mobile phone in one embodiment. The content creator first activates the application, and the controlling application on his phone discerns the phone's location and connects to the controlling agency and informs it and the server of the location of the mobile phone. Then, the content creator puts the necessary information into the condition process (15) and uses the Geo-fencing guidelines input interface (86) to create geo-fencing guidelines (80). These are sent to the server, where the controlling application checks to see if they are acceptable. If they are not acceptable, the content creator may either set up new geo-fencing guidelines or decide not to have geo-fencing guidelines. The user then uses the condition process to set up the requirements for re-broadcasters. If these are acceptable, then the event is added to the list of re-broadcasters under terms. If these are not acceptable, the controlling agency prevents the event from being re-broadcasted.

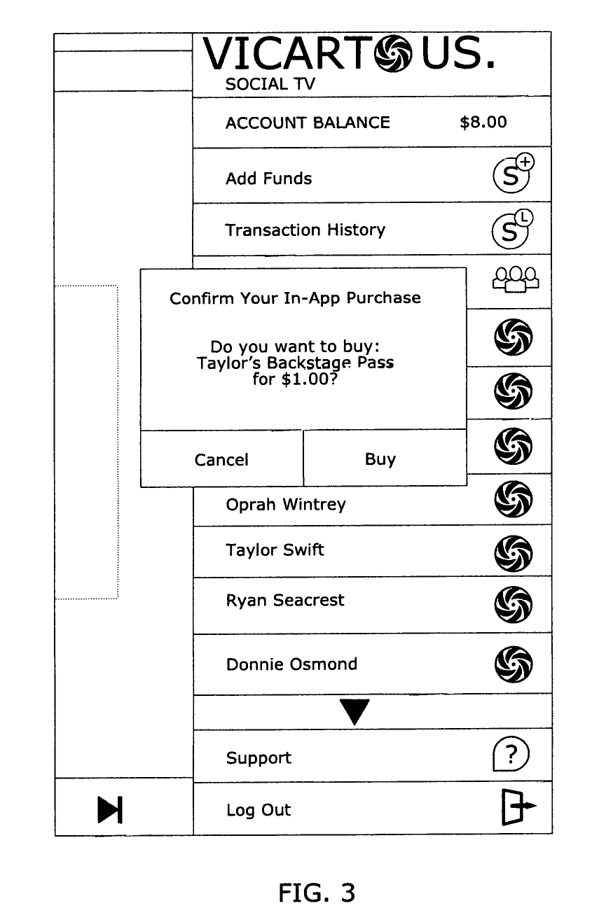

FIG. 3 shows the screen a viewer might see when he or she is about to purchase access to an event in one embodiment of the invention. Viewers (and users) can purchase access to such events, which generates revenue for content creators and users. The payment of revenues, when such revenues are paid to a content creator or user, or split between them, can be accomplished by technologies already known in the prior art.

In sum, the present invention provides a system and methods for Content Capture, Distribution and Management. The advantages of such a system include the ability for a performer or other content creator to select a distribution channel(s) to maximize exposure or income. In addition, by using modern technology, a record is generated that may be suitable for subsequent editing either alone or in conjunction with multiple performances. The system also enables a performer or other content creator to control any business arrangements that may be established, surrounding a performance. Another advantage is that content distribution may be easily controlled by the performer or other content creator and not by a third party.

While this invention has been described in terms of several embodiments, there are alterations, modifications, permutations, and substitute equivalents, which fall within the scope of this invention. Although sub-section titles may have been provided to aid in the description of the invention, these titles are merely illustrative and are not intended to limit the scope of the present invention.

The system can be used at schools, universities, corporate communications, fitness centers, adventures, after parties in Hollywood, back stage Hollywood, reality TV and on and on. The above example also opens up the possibility of auctions for the live event for any re-broadcaster. In effect, the entire solution is all about bringing the content provider directly together with the fan/consumer. Combining the simplicity of a mobile app on a mobile device with this, enables any content provider to start broadcasting.

Re-broadcasting in the system is also fun with picture in picture capability. The rear HD camera records the event while the front camera optionally shows the broadcaster. This enables everyone to become part of the system.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

The discussion included in this patent is intended to serve as a basic description. The reader should be aware that the specific discussion may not explicitly describe all embodiments possible, and alternatives are implicit, or obvious to those skilled in the art. Also, this discussion may not fully explain the generic nature of the invention and may not explicitly show how each feature or element can actually represent equivalent elements. Again, these are implicitly included in this disclosure. Where the invention is described in device-oriented terminology, each element of the device implicitly performs a function. It should also be understood that a variety of changes may be made to the embodiments that have been described, without departing from the essence of the invention. Such changes are implicitly included in the description. These changes still fall within the scope of this invention.

The reader should also understand that components that perform the same functions, within the invention, as the components described herein are explicitly within the scope of the claimed invention.

Furthermore, each of the various elements of the invention and claims may also be achieved in a variety of manners. This disclosure should be understood to encompass each such variation, whether it is a variation of an apparatus embodiment, a method embodiment, or a variation in any element of an embodiment. As the disclosure relates to elements of the invention, the words describing each element may be replaced by equivalent apparatus terms, even if only the function or result is the same. Such equivalent, broader, or even more generic terms should be considered to be encompassed in the description of each element or action. Such terms can be substituted, when desired, to make explicit the implicitly broad coverage to which this invention is entitled. It should be understood that all actions may be expressed as a means for taking the action in question, or may be expressed as an element for causing the action in question. Similarly, each physical element disclosed should be understood to encompass a disclosure of the action which that physical element facilitates. Such changes and terms are to be understood to be explicitly included in the description.

1. We claim a method for capturing and distributing content comprising;
an application which can be operated on a smartphone or computer, that allows a content creator to capture and broadcast audio and video content via livestreaming, and said method further comprising a controlling agency, which is a computer program capable of being operated on one or more servers;
and said method further comprising that said application can communicate wirelessly with said controlling agency;
so that said application has the ability to request that said controlling agency create a geo-fence;
and said controlling agency further having the capability to create a geo-fence of the type requested by said application, that prevents other subscribers, excepting those subscribers who have been given permission send said audio and visual content from said content creator, from using other copies of said application to live-stream audio or video content in the area included in said geo-fence,
so that only said content creator, and those subscribers who have been given permission to send said audio and visual content from said content creator, can livestream said audio and visual content from the area enclosed by said geo-fence.

2. The method of claim 1, further comprising that said controlling agency includes a group of potential attributes for said geo-fence,
said attributes including the radius and diameter of the area enclosed by said geo-fence, and said method further comprising that said application includes the ability for the content creator to select from among said potential attributes and transmit said selection to said controlling agency, so that said controlling agency will then create said geo-fence according to the attributes selected by said content creator.

3. The method of claim 1, said method further comprising that users may submit bids for the right to be excepted from said geo-fence and to broadcast said content, through either directly capturing said content on a device, or being transmitted said content from the content creator's device,
and said method further comprising determining the winning bidder from among those bidders who have submitted bids for the right to be excepted from said geo-fence and broadcast said content;
said method further comprising that said winning bidder is excepted from said geo-fence and allowed to broadcast said content;
and said method further comprising that said winning bidder receives the data stream created by the livestreaming of the event, and said winning bidder causes said data stream to be transmitted to other subscribers.

4. The method of claim 1, further comprising that said application sends said controlling agency the location of said device when said application is activated;
and said method additionally comprising that said controlling agency comprises a plotting module;
and said method additionally comprising that when said geo-fence is geographic in nature said controlling agency creates said geo-fence, by plotting the location of said device, and plotting the area around said device, where said area has dimensions selected by said content creator, and said plotting module creates said geo-fence enclosing said area.

5. The method as in claim 1, wherein said server is a distributed cloud of computers.

6. The method of claim 3, further comprising that said winning bidder is determined by comparing the attributes of each bidder with a list of pre-determined attributes that are provided by the content creator, said attributes including at least one of the following;
a) that a bidder is a preferred user;
b) that a bidder is using a preferred device to broadcast content;
c) the bidder has a preferred distribution capability;
d) selecting a specific bidder will help the content creator to reach a preferred financial target;
and selecting as the winning bidder that bidder whose bidder attributes most closely match the desired pre-determined attributes provided by the event sponsor.

7. The method of claim 3, further comprising that said winning bidder is selected by said controlling agency via an algorithm which is previously programmed into said controlling agency, said algorithm including at least on of the following attributes;
a. that a bidder is a preferred user;
b. that a bidder is using a preferred device to broadcast content;
c. the bidder has a preferred distribution capability;
d. selecting a specific bidder will help the content creator to reach a preferred financial target.
and said controlling agency selects as the winning bidder that bidder whose bidder attributes most closely match the desired pre-determined attributes provided by the event sponsor.

8. The method of claim 3, further comprising that while said losing bidders are within the area enclosed by said geo-fence the application is disabled on the devices of losing bidders, causing those devices to be unable to capture audio and video content to the application.

9. The method of claim 3, further comprising the step that it is a default condition that all subscribers except winning bidders and the content creator will be unable to capture audio and video content to their devices using the application, when said devices are within the time period enclosed by the geo-fence.

10. The method of claim 1, wherein the data stream representing the content is sent to a receiving server (35), and where said data stream contains information that identifies the sender of the data stream, and said is checked for validity at least once by the receiving server (35), where said data stream is only considered valid if said data stream originates from a device owned by the content creator or a subscriber who has permission to send said audio and visual content from the content creator.

11. The method of claim 1, wherein all subscribers are identified by one or both of geographic location and internet delivery location so that all content delivery restrictions may be properly applied.
